(19) United States
(12) Patent Application Publication
(10) Pub. No.: US 2013/0016725 A1
(43) Pub. Date: Jan. 17, 2013

(54) METHOD AND SYSTEM FOR INTRA-NODE HEADER COMPRESSION

(71) Applicants: Martin Julien, Laval (CA); Robert Brunner, Montreal (CA)

(72) Inventors: Martin Julien, Laval (CA); Robert Brunner, Montreal (CA)

(73) Assignee: TELEFONAKTIEBOLAGET L M ERICSSON (PUBL), Stockholm (SE)

(21) Appl. No.: 12/978,499

(22) Filed: Dec. 24, 2010

(51) Int. Cl. H04L 12/56

(52) U.S. Cl. 370/394

(57) ABSTRACT

One aspect of the invention is directed to a network element (e.g., node/router/switch, etc) which performs internal packet header compression. In particular, an aspect provides a network element comprising a plurality of ingress elements (e.g. line cards), a plurality of egress elements, and system internal network (e.g. a backplane) for switching between the correct Ingress element and egress element, and applying header compression for the purpose of reducing the bandwidth required between the elements. As such internal “metadata” can be added to the compressed header without increasing, and preferably in some embodiments, actually decreasing, the size of the packets. Typically the headers are uncompressed before exiting the egress element.

### TECHNICAL FIELD

This invention relates generally to networking and in particular to methods and systems to make network elements cheaper and more efficient.

### BACKGROUND

As networking systems are required to process more and more data traffic, more processing and bandwidth capacity need to be provided by such systems. To achieve such goals, network elements, such as switches, routers, gateways and other nodes, are typically constructed based on a chassis form-factor, which provides for a scalable number of processing components interconnected through a common system internal network (SIN). A chassis is basically a card cage where electronic boards, often referred to as blades or line cards, can be optionally added or removed. Such a building practice is useful to share efficiently common resources among all the different blades inserted in the chassis. Typically, such systems are built using a common system internal network, (e.g. a backplane) to which each blade is connected. Each blade can be directly interconnected with each other, using links available on the common backplane, or be connected through a central switch fabric managing and making the interconnections. Even though large networking systems are typically built from chassis and blades, it could still be possible to achieve more or less the same system architecture for smaller networking systems using components available in different form-factors.

Such architecture allows for scalable increases to the processing and bandwidth capacity provided by such systems, by allowing for a scalable number of processing components (e.g., blades) interconnected through such a common system internal network. In order for each processing component to communicate with others, messages need to be exchanged between them. Those messages normally include the packets that need to be forwarded and/or processed, along with system's or feature's specific metadata information associated with the processing of each packet. In other words, when packets are exchanged between the different processing components of the system through the system's internal network, metadata information associated with each packet typically has to be propagated, along with the packet itself U.S. Pat. No. 7,411,953, which is hereby incorporated by reference in its entirety, provides an example of such metadata information.

Depending on the size of the metadata, the size of the packet, and the number of processing component inter-communication messages needed, the available bandwidth and latency on the backplane might become a limiting factor. Typically, an extra metadata header is required in order to inform the receiver with information extracted by the sender, such as the state associated with the packet, the requested operations at the receiver side, etc.

However, the fact that extra bytes are needed for the metadata information increases the size of each packet. Assuming that a metadata header can be in the order of tens of bytes and that the minimum packet size for an IP packet over Ethernet is 64 bytes, the metadata header could be considered quite significant, especially when the backplane bandwidth is limited. Depending on the type of systems, the type of internal network, the required processing logic and the minimum packet size supported, the size of the metadata information might become quite significant.

In order to lower cost of systems, it is desirable to reuse standard technologies such as Ethernet both for the line cards and for the system's internal network. While line cards are also using Ethernet to connect to other systems, it becomes extremely challenging to also use the same Ethernet specification using the same bit rate for the communication between system's blades, assuming additional metadata headers need to be added. For example, for packets entering a networking system using a 100 Gbps Ethernet port, and requiring to be forwarded between the system's processing components through the internal network also using a 100 Gbps Ethernet port, it is clear that increasing the size of each packet with metadata information could lead to congestion on the internal network for the worst-case traffic model scenarios. Thus existing SIN's are built with additional capacity, either by means of proprietary design, or by means of utilizing additional SIN capacity than the total supported by the line cards. In legacy systems, it is common to dimension a networking system in order to account for the worse case, which is often requiring between 40% and 60% of overhead on the backplane bandwidth compared to the bandwidth available on a line card. This is inefficient, and adds to the expense of such nodes.

Thus, it would be desirable to achieve a network element design which can efficiently use header compression technologies for the SIN as well as the line cards.

### SUMMARY

It is an object of the present invention to obviate or mitigate at least one disadvantage of the prior art.

A preferred embodiment of the invention, proposes the use of header compression algorithms, not just for inter-node bandwidth savings (as is currently used in the art), but for intra-node communication as well. Accordingly, a broad aspect of the invention is directed to a new use for header compression techniques in order to reduce the bandwidth required on the SIN, and thus enable the reuse of the existing technologies for SIN design and operation

Accordingly, one aspect of the invention is directed to a network element (e.g., node/router/switch, etc) which performs internal packet header compression. In particular, an aspect provides a network element comprising a plurality of ingress elements (e.g. line cards), a plurality of egress elements, and system internal network (e.g. a backplane) for switching between the correct Ingress element and egress element, and applying header compression for the purpose of reducing the bandwidth required between the elements. As such internal “metadata” can be added to the compressed header without increasing, and preferably in some embodiments, actually decreasing, the size of the packets. Typically the headers are uncompressed before exiting the egress element.

An aspect of the invention provides a method for switching packets from an ingress element of a node to an egress element of said node. Such a method comprises receiving a packet at said ingress element, said packet including a received header. The packet is then processed to produce a processed packet, said processing including compressing said received header to remove at least some header data to produce a compressed header. The processed packet is then forwarded said across said node's internal network towards the appropriate egress element, which in turn receives and reassembles the processed packet, said reassembling comprising decompressing said header. For some embodiments according to this aspect said processing further comprises inserting a metadata header into said processed packet, wherein metadata is information used by internal node components. Accordingly the egress element, upon receiving said processed packet utilizes said metadata; and then removes said metadata. For some embodiments according to this aspect, the processing step further comprises evaluating each received packet to determine to which flow said packet pertains, and wherein said compressing step comprises removing header information that can be recreated by said egress element by conveying an indication of said flow. For some embodiments according to this aspect, one or more initial packets of a flow are not compressed during said compressing step while said flow is being identified such that information subsequently to be compressed is initially conveyed to said egress element. Accordingly, it is subsequent packets of an identified flow that are compressed.

According to some embodiments, the compressing step comprises removing at least sufficient header information to make room for said metadata to be inserted during said inserting step. This has the advantage that the bandwidth requirements of the metadata needed by the node do not require the bandwidth capacity of the SIN to be more than the bandwidth capacity of its line cards. This provides an advantage the SIN can utilize standard technologies, which decreases the cost and increases the scalability of nodes.

However other embodiments can further decrease cost of the node, by actually saving sufficient bandwidth that fewer components are required. For example, according to some embodiments, wherein said node comprises a plurality of ingress elements, and wherein said compressing step comprises removing more header information than is necessary to make room for said metadata to be inserted during said inserting step, such that the packet size of said packet as it traverses said node is decreased, such that the bandwidth requirements of said SIN are decreased, such that, in the aggregate, the bandwidth requirements of said SIN are less than the sum of all the bandwidth requirements of all the ingress elements of said node. So in the case of a SIN which utilizes multiple switching or transmission components to produce a total capacity, once sufficient compression is achieved that the aggregate SIN bandwidth requirements are reduced to the point that at least one less such component is required to fully satisfy all of the requirements needed by all of the ingress elements, than further cost advantages are achieved.

In terms of network bandwidth efficiency, there exist several standardized algorithms for compressing packets between two collaborative endpoints of the same system, or of different systems. Several standards describe how to use header compression algorithms for reducing the size of the packets without losing any information of the packets. Each of these techniques has advantages and disadvantages, which can depend on the type of packet, and any flow to which the packet pertains. Depending on the protocols used in the packets, different compression techniques or algorithms might be better optimized for those specific types of packets. Accordingly, another aspect of the invention provides a method and system which determines the flow to which a packet belongs, and the type of header compression algorithm is selected from a plurality of possible header compression algorithms dependent on said flow. In other words, embodiments according to this aspect and can utilize different algorithms for different types of flows; wherein different header compression algorithms can be selected on a per-flow basis, for example, in order to maximize the compression ratio, and optimize the bandwidth used by the SIN.

Preferably the selecting step is executed upon the identification of a newly received flow, and the same header compression algorithm is utilized for each subsequent received packet belonging to said flow.

Another aspect of the invention provides an improved network node which comprises a plurality of ingress elements capable of processing packets and transmitting said packets using a particular networking technology, wherein an aggregate capacity of said ingress elements is X; and a System Internal Network (SIN) which utilizes said particular networking technology with an aggregate capacity of X or less. In such a node, each ingress element comprises a packet processor for processing packets which include a header. Such a packet processor includes a compressor for compressing at least one header to remove some header data to produce a compressed header; and a metadata processor for inserting System Internal Metadata into said packet. In such a system, the compressors remove in the aggregate at least as much header data as inserted by said metadata processor such that said packets transmitted across said SIN has a bandwidth of X or less.

An embodiment according to such an aspect further comprises a plurality of egress elements. In such an embodiment, each packet processor is configured to evaluate each received packet to determine to which flow said packet pertains, and wherein said compressor is configured to remove header information that can be recreated by an egress element receiving said packet by said packet processor conveying an indication of said flow. In some such embodiments the packet processor comprises a selector for selecting from a plurality of possible header compression algorithms a header compression algorithm to be used by said compressor, wherein said selecting is executed upon the identification of a newly received flow and the selection is dependent on said flow, such that the same header compression algorithm is utilized by said compressor for each subsequent packet belonging to said flow. According to further such embodiments, the node includes N ingress elements, with each ingress element including a communication element with bandwidth of y such that X=Ny and wherein said compressors remove sufficient header data in the aggregate such that SIN comprises an integral number of said communication elements less than Ny. It should be appreciated that said egress elements further comprise a suitable packet processor for utilizing said metadata, including a decompressor for decompressing said compressed header in order to reassemble said packet.

Another aspect provides for a blade for use within a network node, said network node including a plurality of blades and a system internal network (SIN), said SIN configured to transport packets between blades using a particular networking technology, said blade comprising a packet processor and a communication interface. In such a system, the packet processor is configured for processing packets which include a header, said packet processor including a compressor for compressing at least one header to remove at least some header data to produce a compressed header; and a metadata processor for inserting System Internal Metadata into said packet. Further, the communications interface is configured to communicate with said SIN using said particular networking technology and to transport packets towards other blades via said SIN.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an exemplary network element, according to a non-limiting exemplary embodiment of the present invention;

FIG. 2 illustrates an example of a packet format for a packet which traverses a system internal network;

FIG. 3 illustrates an exemplary packet format for a packet which traverses a system internal network, according to a non-limiting exemplary embodiment of the present invention;

FIG. 4 is a flowchart illustrating an exemplary method, according to an exemplary embodiment of the invention;

FIG. 5 is a flowchart illustrating a dynamic selection of the best header compression algorithm on a packet flow basis, according to an exemplary embodiment of the invention;

FIG. 6 is similar to FIG. 1, but illustrates the operation of a dynamic selection of the best header compression algorithm on a packet flow basis, according to an exemplary embodiment of the invention;

FIG. 7 is a block diagram illustrating a schematic overview of an exemplary element.

### DETAILED DESCRIPTION

The present invention is directed to methods and systems for packet traversal within a node, wherein the packet headers are compressed to make room for metadata needed to traverse from an ingress element to an egress element of said node.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

In the context where large networking systems need to provide more and more bandwidth and processing capacity, such large systems are typically built using a number of smaller components, which can efficiently interact with each other. Typically, a scalable system architecture design for such large networking systems utilizes the concept of chassis, line cards (also known as blades) and a system internal network (for example a backplane or fabric) for interconnecting the cards. Currently, it is still common to utilize a proprietary system internal network developed specifically to interconnect, at high-speed, the different processing components of a system. However, there are cost, inter-operability and future-proof benefits which can be realized by re-using existing network technologies and components, for the system's internal network, instead of a proprietary solution. Furthermore, while many off the shelf solutions can be advantageous, it is beneficial from a cost perspective to use an inexpensive approach, such as Ethernet, rather than an expensive standard-compliant solution. Accordingly, exemplary embodiments will be discussed using the example of Ethernet over a backplane, however it should be appreciated that other SIN technologies can be used without departing from the scope of the invention.

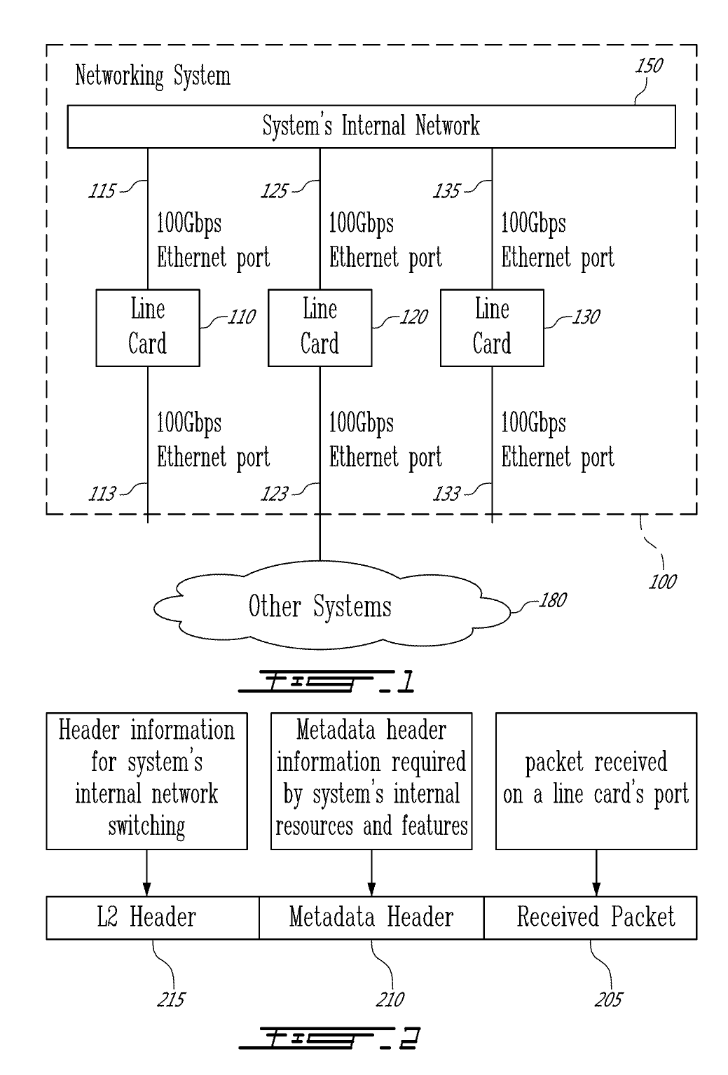

FIG. 1 illustrates an exemplary network element, according to a non-limiting exemplary embodiment of the present invention. As shown in FIG. 1, a network element 100 comprises several line cards 110, 120 and 130, and a system internal network 150, for example a central switch using the same 100 Gbps Ethernet protocol towards each line card. Each line card includes an internal 100 Gbps Ethernet port 115, 125 and 135 (which connects to the SIN 150), and an external 100 Gbps Ethernet port 113, 123 and 133, which connects to the other systems 180. Note that the capacity of a link (channel) may be typically 10 Gbps based on current “state of the art” silicon available. Accordingly, each 100 Gbps link is typically implements as 10×10 Gbps links (e.g., used 10 Serialization/Deserialization links at 10 Gbps). However, 4×25 Gbps links can also be utilized. As stated, one advantage of at least some embodiments, is the ability for the SIN to use existing components for transport. However, as should be appreciated, the fewer components a manufacturer requires to procure and keep in the inventory, the better. Accordingly, an embodiment includes a SIN which includes a plurality of Ethernet transport elements which utilizes the same Ethernet specification using the same bit rate for the communication between system's blades, as is used by the blades themselves.

In this example, each line card can operate as both an ingress element to the SIN 150, and/or as an egress element to the SIN 150. In this figure each line card can operate as both an ingress element to the node 100 (in the sense that the line card receives packets from other systems 180), and as egress element to the node 100 (in the sense that the line card transmits packets from other systems 180). However, it should be appreciated that there can be dedicated ingress and egress cards. Also, a node can have an ingress/egress element to the SIN which is not an ingress/egress element to the node, for example a service element which acts on packets within the node (for example, which implements encryption/decryption). It should also be appreciated that this is a simplified figure useful for discussing embodiments of the invention, without including other elements of a typical system. For example, the line cards can include optical to electrical converters (depending on format used for communication with the other systems), Application Specific Standard Product (ASSP), forwarding elements and processing elements, each of which may include one or more processors, plus machine readable memory for both storing and updating tables for routing and for storing computer executable instructions which are executed by the processors to implement the methods described herein. In addition, the node's internal network 150 can take various forms, such as a backplane or switching fabric, and can include, for example, one or more processing units, switching units, logical addressing modules (including forwarding and processing tables), forwarding, switching and control components, which can be implemented via dedicated hardware, one or more processors and suitable machine readable memory. More details of other elements of a node would depend on the node in question.

Taking the example of a router application providing several line cards, each with a 100 Gbps Ethernet port, then it becomes extremely challenging to also use the same standard 100 Gbps Ethernet specification for the backplane interconnection. Basically, a significant challenge comes from the fact that metadata information is typically required to be exchanged between the different processing components, in addition to the existing packet data. The metadata typically includes information related to states, routing, accounting, metering, etc. Typically such metadata information is added as a pre-pended header to the existing packet. However the addition of this extra metadata requires extra bandwidth which can exceed the maximum bandwidth allowed by the selected transport protocol, potentially congesting the system's internal high-speed network 150 interconnecting the processing components.

The extra bytes needed for the metadata information increases the size of each packet. Assuming that a metadata header can be in the order of tens of bytes and that the minimum packet size for an IP packet over Ethernet is 64 bytes, the metadata header could be considered quite significant, especially when the backplane bandwidth is limited. Depending on the type of systems, the type of internal network, the required processing logic and the minimum packet size supported, the size of the metadata information might become quite significant. It is common to dimension a networking system in order to account for the worse case, which is often requiring between 40% and 60% of overhead on the backplane bandwidth compared to the bandwidth available on a line card.

However, we propose an improved architecture that does not include such excessive internal network dimensioning. Instead one aspect of the invention allows for the reuse of the same networking technology used on the line cards, to be used in the SIN, without requiring a SIN capacity which exceeds the aggregate capacity of the line cards. In order to help reduce the bandwidth required on the SIN, and thus enable the reuse of the existing technologies for SIN design and operation, the preferred embodiment of the invention proposes utilizing header compression algorithms, not just for inter-node bandwidth savings, but for intra-node communication as well.

These compression algorithms (such as the IETF's IP header compression (RFC 2507), the IETF's Compressing IP/UDP/RTP headers for low-speed serial links (RFC 2508), the IETF's RObust Header Compression (ROHC) (RFC 3095, RFC 4815 and RFC 5795), the IETF's Signaling Compression (RFC 3320), etc., each of which is hereby incorporated by reference in its entirety), typically utilize a compressor at the beginning of a link, to compress the IP, UDP, RTP and TCP headers of packets, (either IPv4 or IPv6) from 40-60 bytes into just a few bytes, and then a decompressor after the packet has traversed the link, to decompress the header. Other Header Compression techniques are known, for example, as described in U.S. Pat. Nos. 6,754,231, 7,136,395, and 7,512,716, each of which is hereby incorporated by reference in its entirety. As suggested by the name, header compression algorithms allow packets to be compressed, which means that the algorithms can be used to reduce the size of the packets when possible. For example, a typical ROHC implementation could aim to get the receiver of a compressed packet into a second-order state, where a 1-byte ROHC header could be substituted for a 40-byte IP/UDP/RTP (i.e. voice) header.

In either case, one thing to note is that these Header Compression algorithms are directed to compressing headers of packets which traverse links between nodes. A lot of the improvements to these algorithms have focused on improving them for the links involved (i.e., for inter-node communication). For example, unlike predecessor compression schemes, such as IETF RFC 1144 and RFC 2508, each of which is hereby incorporated by reference in its entirety, RFC 5795 is directed to Robust Header compression as it performs well over links where the packet loss rate is high, such as wireless links.

However, it was determined that, assuming that header compression algorithms can be applied to most of the data traffic, there could be significant gain on the backplane bandwidth that could eventually be used to carry system specific metadata information.

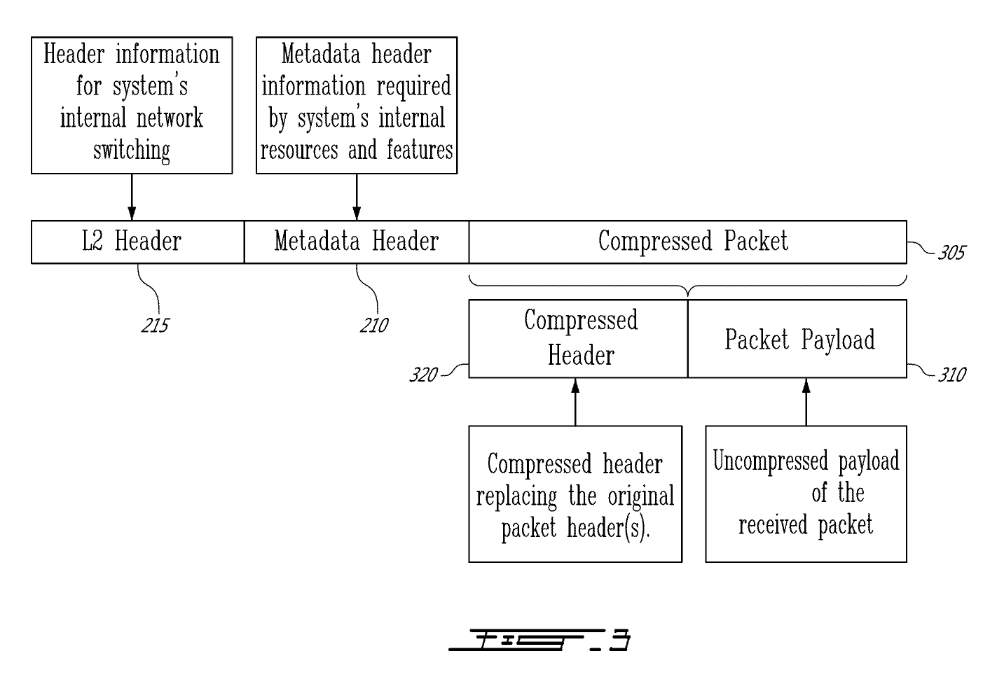

FIG. 2 illustrates a conventional packet format for traversing the SIN, in which the metadata header 210 is pre-pended to the received packet 205, which increases the packet size. The Figure also illustrates a L2 header 215 used to route the packet from the ingress card to the appropriate egress card via the SIN. A packet can be considered to have several different headers (directed to different OSI layers). Typically, the first header 215 is used to switch the packet on the switching fabric, which, in our example, is based on Ethernet. Then the metadata header is used to exchange some proprietary information between the different blades of the system. After that, there is the original packet. The originally received packet 205 may be kept as is, which means also including its received L2 and L3+ headers, (e.g., the IP/UDP/RTP (i.e. voice) headers) plus playload. Alternatively the received L2 header can be stripped, as it is replaced by the L2 header 215 (or the metadata can include the L2 routing info). Alternatively, the received packet portion 205 can include a so called layer 2.5 (such as MPLS) header.

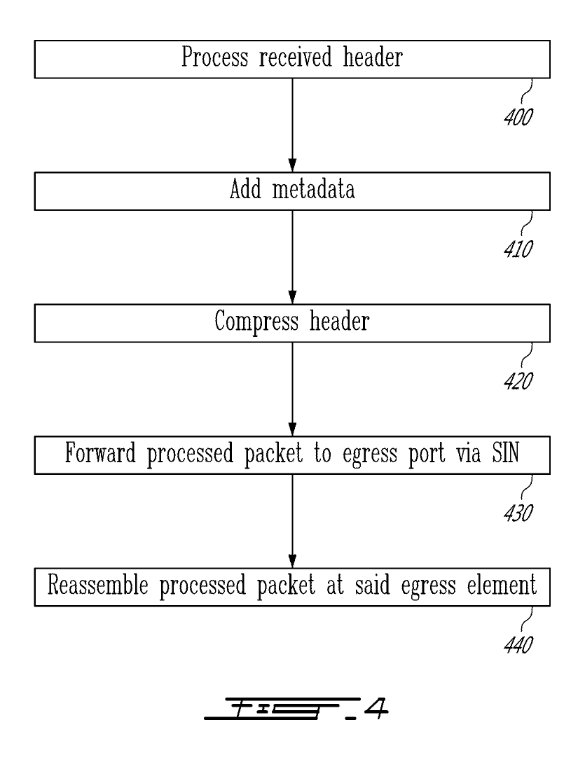

FIG. 3 illustrates an exemplary packet format for a packet which traverses a system internal network, according to a non-limiting exemplary embodiment of the present invention. As can be seen, this packet format also includes metadata header 210 and the L2 header 215 used to route the packet from the ingress card to the appropriate egress card via the SIN. However, rather than the remainder of the received packet 205, according to this embodiment the remaining element is a compressed packet 305 including a compressed header 320 and the received packet payload 310. Note that this figure is schematic in nature and is designed to illustrate the difference between the conventional format and the improved format, according to an embodiment of the invention. However, distinctions between the L2 header 215, the metadata header 210 and the compressed header 320 are somewhat artificial, and can all be considered to be different portions of the processed packet's header. What is being compressed are the headers of the original packet, which typically are the L3 and/or L4 headers (but other headers can also be compressed).

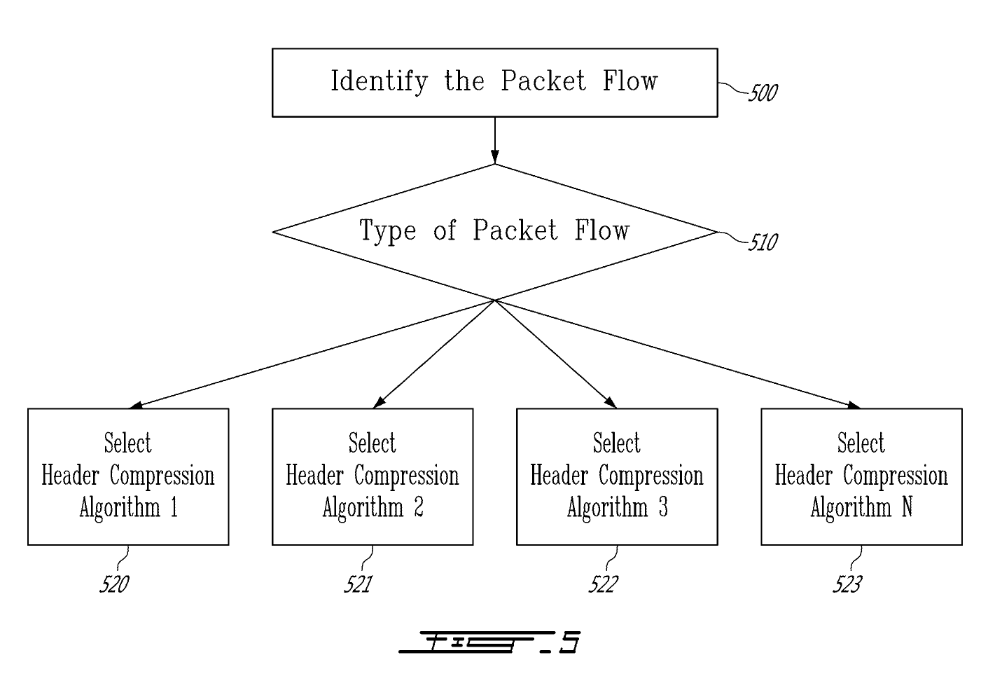

FIG. 4 is a flowchart illustrating an exemplary method for switching packets from an ingress element of a node to an egress element of said node, according to an exemplary embodiment of the invention. The method comprises processing the received header 400 of a received packet to produce a processed packet. This processing includes inserting a metadata header 410 into said processed packet, and compressing said received header 420 to remove at least some header data to produce a compressed header. It should be noted that the order of steps 410 and 420 are not crucial, and as stated above, whether the metadata can be considered pre-pended to the compressed header, or form part of it, is mostly a matter of semantics.

The system then forwards the processed packet across said node's internal network to the appropriate egress element 430, at which point the processed packet is received and reassembled at egress element 440, which includes decompressing the compressed header and optionally utilizing the metadata. It should be appreciated that the above provides an overview, and a person skilled in the art should appreciate that the compression/decompression steps typically involve a state-driven mechanism. For example, the sender (compressor) and the receiver (decompressor) will typically initially exchange a few packets in order to eventually converge towards a compressed version of the header. Further, as should be appreciated from the IETF standards related to packet header compression, there can be different modes of operation and state-machines associated with each compressor and decompressor.

Telecom operators have introduced relatively new classification and routing functions which identify uniquely each stream of packets, referred to as packet flows, in order to better manage and control the data traffic. The way a packet flows is typically identified is by extracting a few fields from the packet itself, in order to find or create a context that would specify clearly certain tasks, such as forwarding and metering, to perform on the packet. The fields extracted from the packet are typically related to the IP address, the OSI's layer 3 protocol, the port numbers, etc. Packet flows can be created statically or dynamically, and can have an extremely long or extremely short life cycle.

The efficiency of a header compression algorithm highly depends on the type of packets, and the duration of the packet flows. In order to header compression schemes to be efficient, several packets need to be exchanged in the same packet flow, i.e. the same packet stream. The longer can be a packet flow life cycle, the more efficient a header compression algorithm can be. For example, assuming that an increasingly large portion of the traffic model is used for carrying video services, which typically require large packets and long-lived packet flows, the efficiency of such header compression algorithms could be very high.

While there are several header compression algorithms available, it is possible that only one would be provided by a system, according to one embodiment of the invention. In such a system, the header compression algorithm available on the system would most probably be selected based on the expected traffic model on the system, the ability to reuse existing (and/or already licensed) technology, etc.

Even though header compression algorithms can be efficient for reducing the size of packets the actual bandwidth saving highly depends on the traffic model, i.e. the types of packets going through the networking system, the size of the packets, and the duration of each packet flow. Typically, the benefit from using a header compression algorithm is greater as the expected duration of the packet flow is longer. For example, in the case of the ROHC algorithm, it might take several packets of the same packet flow before reaching the second-order state.

While systems can be limited to a unique implementation of a header compression algorithm which best covers their main goal, the concept of selecting the header compression algorithm best suited to the description of the packet flow brings a lot of flexibility. As packet flow identification techniques are becoming more advanced, it is envisioned that several header compression algorithms could also be made available on a single system, so that each packet flow could benefit from the header compression algorithm that could better optimize the backplane bandwidth.

Each header compression algorithm is designed typically for addressing a specific set of protocols, with expected characteristics and performance. While one header compression algorithm can be optimized for web applications, another algorithm could be optimized for video services, voice services or simply control signaling. In other words, as multiple packet flows traverse a networking system, each can utilize a packet flow-based header compression algorithm best suited for the flow in question. Accordingly, an embodiment of the invention provides for allowing a dynamic selection of the best header compression algorithm on a packet flow basis.

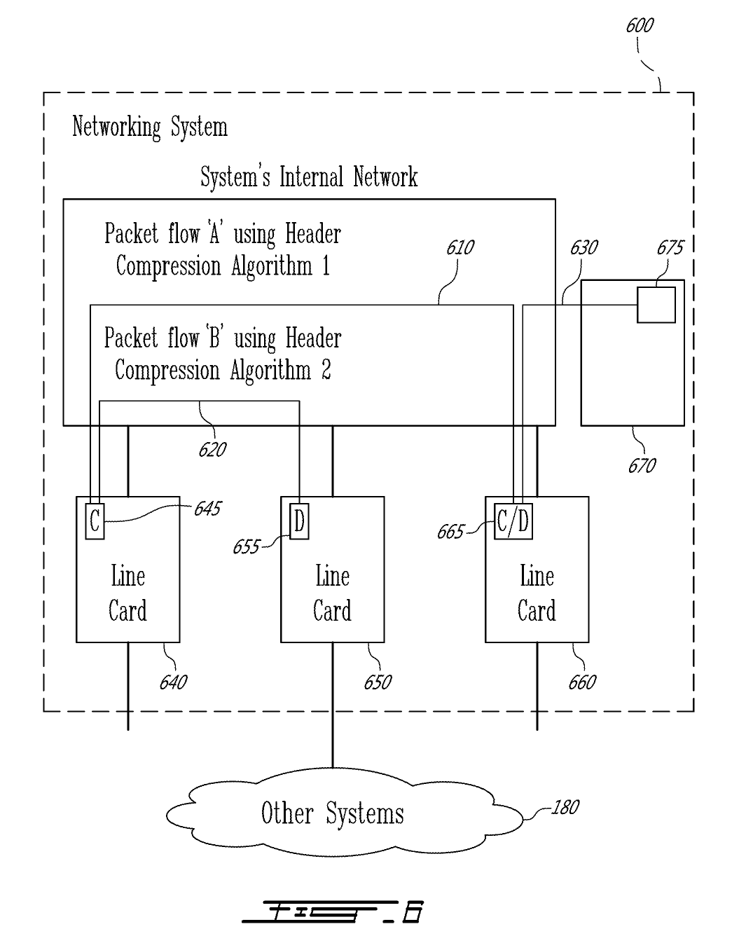

Accordingly, FIG. 5 is a flowchart illustrating such a dynamic selection of the best header compression algorithm on a packet flow basis, according to an exemplary embodiment of the invention. Accordingly, part of the processing of the first (few) packet(s) of a flow is to identify the packet flow 500. Deep Packet inspection techniques can be implemented. The type of packet flow 510 is determined, in order to select an appropriate header compression algorithm (HCA) based on the type of flow. Accordingly, the system can select to use any one of HCA 1, HCA 2, HCA 3 . . . HCA N as shown at 520, 521, 522 . . . 523 respectively.

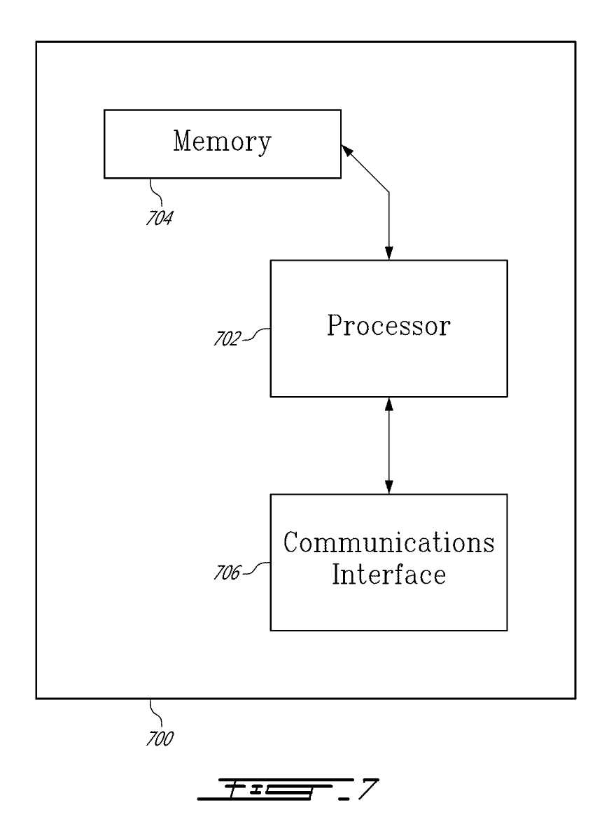

FIG. 6 is similar to FIG. 1, but illustrates a few additional features, and the operation of the dynamic selection of the best header compression algorithm on a packet flow basis, according to an exemplary embodiment of the invention. In this example, Packet flow A is shown 610 to traverse the SIN 150 between Line Card 110 and Line Card 130, whereas Packet flow B is shown 620 to traverse the SIN 150 between Line Card 110 and Line Card 120. In this example, Packet Flow A is considered to be of a different type then Packet Flow B, and accordingly, a different HCA is selected. For example, Packet Flow ‘A’ carries time critical packets and the Header Compression Algorithm 1 is selected, as it is simple and fast. However, Packet Flow ‘B’ carries video packets and accordingly Header Compression Algorithm 2 is selected as it maximizes the compression ratio and is optimized for large packets and long lasting streams.

In addition, FIG. 6 illustrates an example of line card 640 acting solely as an ingress blade, and line card 650 acting solely as an egress element. Accordingly, line card 640 is illustrated to include a compressor 645, which implements the compression for flows 610 and 620. Similarly, line card 650 is illustrated as acting solely as an egress blade, and accordingly line card 650 is illustrated to include a decompressor 655, which implements the decompression for flow 620. Additionally FIG. 6 illustrates an example of line card 660 acting both as an ingress and egress element. Accordingly, line card 660 is illustrated to include a compressor/decompressor 665, which implements the compression for flow 630 and decompression for flow 610.

Such a compressor, decompressor or compressor/decompressor are typically implemented by means of a processor executing machine readable instructions stored in a suitable memory. The processor and memory of the compressor can be the same or different as the main processor and/or memory of the line card, and it should be appreciated that dedicated hardware can also be used.

It was discussed hereinbefore examples in which each blade or element involved with the compression or decompression of a flow is a line card which either receives packets from, or transmits packets to the other systems 180. However, aspects of the invention apply to blades or elements that are not limited to line cards, and other elements that transmit or receive packets within a node via the SIN can benefit from the header compression techniques discussed herein. FIG. 6 also illustrates an example wherein a blade or element is not a line card. FIG. 6 includes internal element 675, which can compress (and/or decompress) packets for transmission via the SIN. In this exemplary embodiment, service element 675 is an element that receives compressed flow 630, and processes the packets in some manner. For example, 675 can include a decryptor for decrypting received packets for further processing. Element 675 can then compress the decrypted packets that then flow via the SIN to another element (not shown). As yet another example, 675 can represent a video server, which compresses the headers of video packets for internal transmission via flow 630 to egress card 660. Accordingly, reference was made to ingress and egress elements, which can include line cards and other blades, with ingress and egress referring to ingress to, and egress from, the SIN. It should also be appreciated that the compressor and/or decompressor need not be included in the line cards themselves, but can be included as intermediate elements in the path between the line cards and the SIN. In such cases, the intermediate elements can be considered the ingress/egress elements.

FIG. 7 is a block diagram illustrating a schematic overview of an exemplary element 700, for example an ingress or egress element. As can be seen, such an element includes a communications interface 706, a processor 702 and an associated machine readable medium, shown as memory 704. The machine readable medium includes machine readable instructions, which when executed by said processor, implements the methods described herein. According to one such an embodiment the machine readable medium includes machine readable instructions, which when executed by said processor, implements a packet processor as discussed herein such a packet processor can include a compressor for compressing at least one header to remove at least some header data to produce a compressed header; and a metadata processor for inserting System Internal Metadata into said packet.

For example, in some embodiments, the packet processor is configured to evaluate each received packet to determine to which flow said packet pertains, and wherein said compressor is configured to remove header information that can be recreated (by other elements which receive the process packets), by conveying an indication of said flow. Accordingly, according to such an embodiment, the machine readable medium includes instructions which implements a selector (which can form part of said packet processor) for selecting from a plurality of possible header compression algorithms a header compression algorithm to be used by said compressor, wherein said selecting is executed upon the identification of a newly received flow and the selection is dependent on said flow, such that the same header compression algorithm is utilized by said compressor for each subsequent packet belonging to said flow. It should be appreciated that in some embodiments, such a packet processor can include a corresponding decompressor (either in conjunction with, or instead of said compressor).

With the capability of selecting a specific header compression algorithm on a packet flow-basis, it becomes easier to support functions for adding/upgrading/removing header compression algorithms dynamically on a system. Accordingly, an embodiment allows for the addition of new compression techniques and algorithms that can be dynamically added/upgraded/removed. Allowing compression techniques and algorithms to be dynamically managed brings a better flexibility related to the bandwidth optimization of a system's internal network.

While a header compression scheme could be selected on a packet flow basis on a networking system, the concept could also be applied to the external network, i.e. between different systems that would be capable of sharing information on the header compression algorithms supported and the packet flows transiting between them. This flexibility can become extremely important as the requirement for identifying more and more types of packet flows increases in the future.

Also, apart from the previous advantages of selecting different header compression algorithms, using those algorithms can also bring their own advantages to complete solutions utilizing embodiments of the invention, such as possibly decreasing the BER, the latency, etc.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for switching packets from an ingress element of a node to an egress element of said node comprising:
Receiving a packet at said ingress element, said packet including a received header;
Processing said packet to produce a processed packet, said processing including compressing said received header to remove at least a portion of header data to produce a compressed header;
Forwarding said processed packet across said node's internal network towards the egress element;
Receiving said processed packet at said egress element; and
Reassembling said processed packet at said egress element, said reassembling comprising decompressing said header.

2. The method of claim 1 wherein:
a. said processing further comprises inserting a metadata header into said processed packet, wherein the metadata header comprises information used by internal node components;
b. said receiving said processed packet further comprises utilizing said metadata header; and
c. said Reassembling further comprises removing said metadata header.

3. The method of claim 2, wherein said processing step further comprises evaluating each received packet to determine to which flow said packet pertains, and wherein said compressing step comprises removing header information that can be recreated by said egress element by conveying an indication of said flow.

4. The method of claim 3, wherein one or more initial packets of a flow are not compressed during said compressing step while said flow is being identified such that information subsequently to be compressed is initially conveyed to said egress element; and wherein subsequent packets of an identified flow are compressed.

5. The method of claim 4 wherein said processing step comprises producing packets including compressed header information and inserted metadata without increasing the average size of processed packets of a flow, such that the same networking protocol used by said ingress and egress elements can be used by said internal network.

6. The method of claim 4 wherein said header compression reduces the bandwidth requirements for a flow of packets to traverse said system internal network, such that additional received packets can be processed by said node's internal network.

7. The method of claim 4, wherein said compressing step comprises removing at least sufficient header information to make room for said metadata to be inserted during said inserting step.

8. The method of claim 4, wherein said node comprises a plurality of ingress elements, and wherein said compressing step comprises removing more header information than is necessary to make room for said metadata to be inserted during said inserting step, such that the average packet size of packets of a flow that traverse said node is decreased, such that the bandwidth requirements of said SIN are decreased, such that, in the aggregate, the bandwidth requirements of said SIN are less than the sum of all the bandwidth requirements of all the ingress elements of said node.

9. The method of claim 4 wherein said processing step comprises selecting from a plurality of possible header compression algorithms a header compression algorithm dependent on said flow.

10. The method of claim 9, wherein said selecting step is executed upon the identification of a newly received flow, and the same header compression algorithm is utilized for each subsequent received packet belonging to said flow.

11. The method of claim 3 wherein said node's internal network is a backplane.

12. The method of claim 3 wherein said node's internal network is a fabric.

13. The method of claim 3 wherein said networking protocol is Ethernet.

14. A blade for use within a network node, said network node including a plurality of blades and a system internal network (SIN), said SIN configured to transport packets between blades using a particular networking technology, said blade comprising:
a. a packet processor for processing packets which include a header, said packet processor including:
i. a compressor for compressing at least one header to remove at least a portion of header data to produce a compressed header; and
ii. a metadata processor for inserting System Internal Metadata into said packet; and
b. a communications interface configured to communicate with said SIN using said particular networking technology and to transport packets towards other blades via said SIN.

15. A blade as claimed in claim 14 wherein said packet processor is configured to evaluate each received packet to determine to which flow said packet pertains, and wherein said compressor is configured to remove header information that can be recreated by said other blades by conveying an indication of said flow.

16. A blade as claimed in claim 15 wherein said processor comprises a selector for selecting from a plurality of possible header compression algorithms a header compression algorithm to be used by said compressor, wherein said selecting is executed upon the identification of a newly received flow and the selection is dependent on said flow, such that the same header compression algorithm is utilized by said compressor for each subsequent packet belonging to said flow.

17. A network node comprising:
a. A plurality of ingress elements capable of processing packets and transmitting said packets using a particular networking technology, wherein an aggregate capacity of said ingress elements is X;
b. A System Internal Network (SIN) which utilizes said particular networking technology with an aggregate capacity of X or less;
Wherein each ingress element comprises:
i. a packet processor for processing packets which include a header, said packet processor including:
1. a compressor for compressing at least one header to remove some header data to produce a compressed header; and
2. a metadata processor for inserting System Internal Metadata into said packet;
Such that said compressors remove in the aggregate at least as much header data as inserted by said metadata processor such that said packets transmitted across said SIN has a bandwidth of X or less.

18. A network node as claimed in claim 17, wherein said node further comprises a plurality of egress elements; and wherein said packet processor is configured to evaluate each received packet to determine to which flow said packet pertains, and wherein said compressor is configured to remove header information that can be recreated by an egress element receiving said packet by said packet processor conveying an indication of said flow.

19. A network node as claimed in claim 18 wherein said packet processor comprises a selector for selecting from a plurality of possible header compression algorithms a header compression algorithm to be used by said compressor, wherein said selecting is executed upon the identification of a newly received flow and the selection is dependent on said flow, such that the same header compression algorithm is utilized by said compressor for each subsequent packet belonging to said flow

20. A network node as claimed in claim 19, wherein each node includes N ingress elements, with each ingress element including a communication element with bandwidth of y such that X=Ny and wherein said compressors remove sufficient header data in the aggregate such that SIN comprises an integral number of said communication elements less than Ny.
